(19) United States
(12) Patent Application Publication
(10) Pub. No.: US 2004/0073942 A1
(43) Pub. Date: Apr. 15, 2004

(54) Apparatus of filtering noise for providing internet service using master antenna television network

(76) Inventors: Sin-Yul Park, Kyeonggi-do (KR); Dong-Hee Choi, Kyeonggi-do (KR); Kyung-Keon Park, Kyeonggi-do (KR)

Correspondence Address: Pennie & Edmonds, 1667 K Street NW, Washington, DC, 20006, US

(21) Appl. No.: 10/468,164

(22) PCT Filed: Feb. 16, 2002
(86) PCT No.: PCT/KR02/00239

(30) Foreign Application Priority Data
Feb. 16, 2001 (KR) 2001-7941

(51) Int. Cl. H04N 5/21; H04N 5/217; H04N 7/173

(52) U.S. Cl. 725/124; 348/607

(57) ABSTRACT

The present invention discloses a filtering apparatus for internet service using master antenna television(MATV) network. More particularly, the filtering apparatus according to present invention relates to a filtering apparatus for providing internet service using master antenna television network already installed in apartments or buildings, comprising a high pass filter for removing noise flowing into downward signal input into the master antenna television network via HFC network; a band pass filter for removing noise flowing into upward signal transmitted from internet terminals to the MC network through the master antenna television network; and amplifier, connected to a rear end of the band pass filter, for restoring the upward signal level decreased through the band pass filter to the original signal level by amplifying the filtered upward signal level. According to the present invention, mutual-directional data communication through the master antenna television network is possible by removing unnecessary noise flowing into the upward signal of the master antenna television network.

### BACKGROUND OF THE INVENTION

(a) Field of the Invention

The present invention relates to an apparatus of filtering noise used for providing internet service using master antenna television network installed on a complex building such as apartments, a shopping district, a building, a school, a hotel, or an inn.

(b) Description of the Related Art

Generally, master antenna television network(MATV Network) is installed on each of a complex building such as apartments, a building, a hotel, or a school to allow multiple household to watch programs of various channels. Here, master antenna television network means a single receiving system connecting various televisions in a same building or an area where buildings are clustered close together, that is, cable network allowing watching TV by building up a main antenna to distribute TV signal to plural television sets.

Especially in an apartment complex where plural household are clustered, there are frequent occasions that local cable TV companies are connected with the master antenna television network to satisfy desire of plural watching TV household. The local cable TV companies generally use optical fiber cables to send TV signal from a cable radio relay station to nodes close to end users and coaxial cables to send TV signal from the nodes to set top boxes of end users. Such technique using both of optical fiber cables and coaxial cables in different parts of network to send TV signal formed of video and audio data is called HFC(Hybrid Fiber Coaxial Cable) communication technique.

According to the HFC communication technique, signal with trustworthy superior transmitting property of optical fiber cable may closely be transmitted to end users without changing existing coaxial cables already installed on companies or homes. In addition, according to the HFC communication technique, since the optical fiber cable is used as backbone pipe, more data may be transmitted in wide bandwidth than that when only the coaxial cable is used to allow supporting mutual-directional data transmitting service based on a server/client model. Further, since the optical fiber cable installed on foundational facilities has higher trustworthiness than the coaxial cable, the same may more efficiently used for connecting networks of cable TV companies or telephone companies. Accordingly, many cable TV companies and telephone companies replace the conventional network with the HFC network in these days.

The detailed description of a process sending cable TV signal through the HFC network or MATV network referring to FIG. I is as follows. First, cable TV signal transmitted from a cable TV(CATV) transmitting station 12 is transmitted to each user's cable TV signal receiving device 42 connected with MATV network 45 inside a complex building 40 or a cable TV signal receiving device 23 comprising a converter 22 for receiving cable TV signal through an optical fiber cable network 17 and a coaxial cable network 19.

More particularly, the cable TV signal transmitted from the cable TV transmitting station 12 is modulated into fiber-optic signal in an optical transmitter 15 and transmitted to an optical network 17 through optic fiber cable and the fiber-optic signal is converted into electric signal in an optical network unit(ONU) 18 and transmitted to a coaxial cable network 19. The cable TV signal converted into the electric signal is transmitted through the coaxial cable and then diverged and transmitted to homes or a complex building like apartments through a separator 20. Accordingly, in case of homes, that is, independent houses, the CATV signal is received through a cable TV receiver 23 comprising a converter 22 for CATV and in case of a complex building 40 like apartments, the CATV signal is received through each user's cable TV receiver 42 via MATV network 45.

On the other hand, internet service through HEC network is restrictively provided now, the detailed description of the same is as follows. First, an internet data packet transmitted through the internet network 10 passes a router 11 and the internet data packet transmitted through the router 11 is converted into data receivable for a cable modem through CMTS(Cable Modem Termination System) 13. The converted internet data is combined with the cable TV transmitting signal and transmitted to the optical network 17 through the optical transmitter 15 and the transmitted complex signal is transmitted to each building to which the internet service is to be provided through coaxial cable network 19 and separator 20 by using the HFC communication technique.

The complex signal transmitted to each building is separated into internet signal and cable TV signal by a signal separating unit 21 and the internet signal of the separated signals is converted into signal cognizable for a PC terminal 25 through a cable modem 24 to allow receiving internet data.

On the other hand, a process of transmitting data from the PC terminal 25 to the internet network 10 is progressed in opposite order to that of the internet data receiving process. That is, data transmitted from the PC terminal 25 is transmitted to the coaxial cable network 19 through the cable modem 24 and the data converted into fiber-optic signal in the optical network unit 18 is transmitted to the optical receiver 16 through the optical network 17. The data received from the optical receiver 16 is converted into an internet data packet in CMTS 13 and transmitted to the internet network 10 through the router 11.

However, when the model for mutual-directionally transmitting the internet data using the HFC network is applied to the master antenna television network 45 built in a complex building 40 such as apartments, it is impossible to transmit trustworthy internet data because of various unnecessary noises coming into upward signal transmitted through the master antenna television network 45. Accordingly, the internet service using the master antenna television network 45 is not provided now and in case of a complex building such as apartments, a shopping district, a building, a school, a hotel, or an inn using the master antenna television network 45, the internet service is generally provided with mixing and testing various methods. For example, the internet service is provided by ADSL, apartment net, home LAN, or cable modem wired on the outer wall.

However, such methods comprise various defects. For example, problems that it costs more to build a new network, the installation is complicated in case of a large apartment complex because every line for each home should be searched and then signal is come into each line, it is difficult to add additional equipments along with user's increase, a space for placing headends is limited in case of the apartment or the complex shopping district, various types of lines occupy more and more the space since the line for each home is one, noise coming into the upward signal affects much the internet communication but it is impossible to effectively remove the noise may be mentioned.

### SUMMARY OF THE INVENTION

The object of the present invention is to provide an apparatus for filtering noise for providing internet service using master antenna television network allowing simplifying installation work for internet service, cutting down on expense for building internet service network, and transmitting high-quality data by providing internet service by using master antenna television network installed when a complex building such as apartments or a building are newly constructed.

To achieve the above object, an apparatus of filtering noise for providing internet service using master antenna television network according to the present invention relates to a filtering apparatus for providing internet service using master antenna television network, comprising a high pass filter for removing noise flowing into downward signal input to said master antenna television network via HFC network; a band pass filter for removing noise flowing into upward signal transmitted from internet terminals to the HFC network through said master antenna television network; and an amplifier, connected to a rear end of said band pass filter, for restoring the upward signal level decreased through said band pass filter to the original signal level by amplifying the filtered upward signal level.

According to the filtering apparatus of the present invention, plural band pass filters and amplifiers preferably are mounted in an upward signal filtering area.

According to the filtering apparatus of the present invention, the filtering apparatus may further comprise a mixer, on a front end of said band pass filter, for filtering said upward signal at intermediate frequency by mixing said upward signal with intermediate frequency generated from a local oscillator to modulate said upward signal.

According to the filtering apparatus of the present invention, the filtering apparatus may further comprise a diplex filter for separating said upward signal and downward signal on front ends of said high pass filter and said band pass filter for filtering noises flowing into said upward signal and downward signal after separating each signal.

According to the filtering apparatus of the present invention, the filtering apparatus may further comprise a level regulating section, connected to a rear end of said amplifier, for regulating the level of said upward signal into predetermined optimum level.

According to the filtering apparatus of the present invention, the level regulating section comprises a level measuring section for measuring signal level of the upward signal flowing into said level regulating section and comparing said measured level with predetermined optimum level; and a level converting section for regulating the signal level of said upward signal to the predetermined optimum level.

According to the filtering apparatus of the present invention, the master antenna television network may be used for internet network by removing noise such as filtering downward signal to be 55˜750 MHz band zone by high pass filter and filtering several times upward signal to be 5-52 MHz band zone and amplification.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or the similar components, wherein:

FIG. 1 is a structural diagram of master antenna television network according to the conventional art;

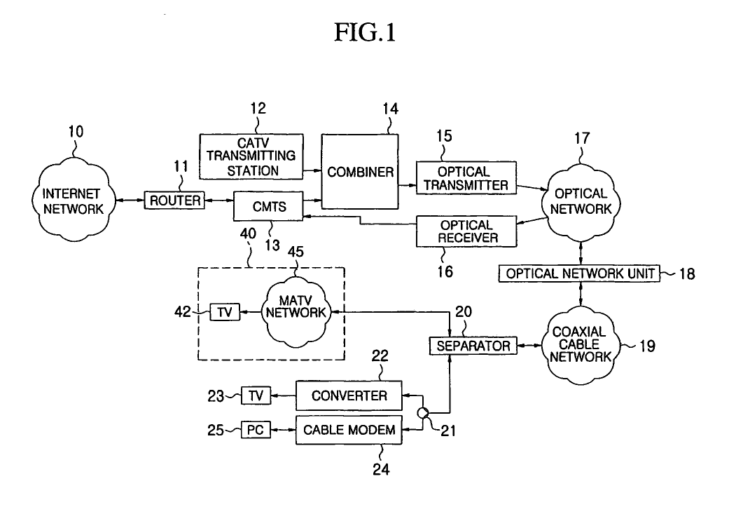

FIG. 2 is a structural diagram of network for providing internet service using master antenna television network embodied by using a filtering apparatus according to the present invention;

FIG. 3 is a block diagram of a filtering apparatus for internet service using master antenna television network according to an embodiment of the present invention; and

FIG. 4 is a block diagram of a level regulating section comprised in the filtering apparatus for internet service using master antenna television network according to an embodiment of the present invention.

### DETAILED DESCRIPTION OF THE PREFERRED EMBODIMENTS

The detailed description of the present invention referring to the experimental examples and embodiments is provided hereinafter. However, the embodiments according to the present invention can be modified in various ways and the claims of the present invention should not be understood to be restricted to the embodiments described below. The embodiments of the present invention are provided to more clearly and easily describe the present invention to a person who has standard knowledge in this technical area. In drawings, the identified references designate the identified elements.

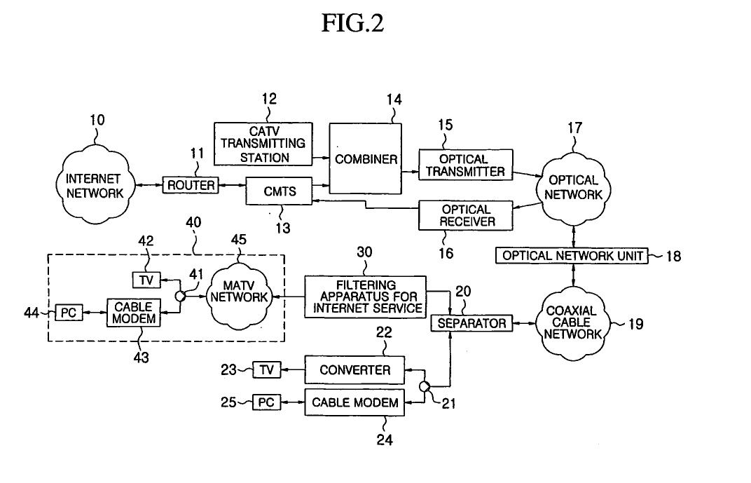

FIG. 2 is a structural diagram of network for providing internet service using master antenna television network embodied by using a filtering apparatus according to the present invention.

As shown in FIG. 2, when a filtering apparatus 30 for internet service according to the present invention is installed between a master antenna television network 45 built in a complex building 40 such as apartments, a building, a hotel, or a school and a separator 20, mutual-directional data communication with an internet network 10 may be possible to allow providing internet service.

An internet data packet transmitted through the internet network 10 passes through a router 11 and the data packet transmitted through the router 11 is converted into data ready for the cable modem's receiving through CMTS(Cable Modem Termination System) 13. The converted internet data is combined with cable TV transmitting signal in a combiner 14 and transmitted to an optical network 17 through an optical transmitter 15 and the transmitted complex signal is transmitted to each building to which the internet service is to be provided through coaxial cable network 19 and separator 20 by using the HFC communication technique.

Downward signal of the internet data entering a master antenna television network 45 of a complex building 40 such as apartments, a building, a hotel, or a school passes a process of removing its noise through a high pass filter(HPF) 32 of filtering apparatus for internet service according to the present invention, the signal entering each home through the master antenna television network 45 of the complex building 40 is separated into internet signal and cable TV signal by a signal separating unit 41, and the separated internet signal is converted into signal cognizable for a PC terminal 44 through a cable modem 43 to allow receiving downward signal of internet data.

On the other hand, a process of transmitting upward signal transmitted from the PC terminal 44 to the internet network 10 is progressed in opposite order to that of the downward signal receiving process and noise of upward signal is also removed by the filtering apparatus 30 for internet service according to the present invention that removes noise of downward signal. That is, upward signal transmitted from the PC terminal 44 passes a process of removing various unnecessary noise entering the master antenna television network 45 by passing through a band pass filter(BPF) 38 and an amplifier 37a and 37b of the filtering apparatus 30 for internet service mounted on the master antenna television network 45 via the cable modem 43. The upward signal from which noise is removed is transmitted to a coaxial cable network 19, converted into fiber-optic signal in an optical network unit 18, and transmitted to an optical receiver 16 through the optical network 17. The upward signal input into the CMTS 13 through the optical receiver 16 is converted into an internet data packet and transmitted to the internet network 10 through the router 11.

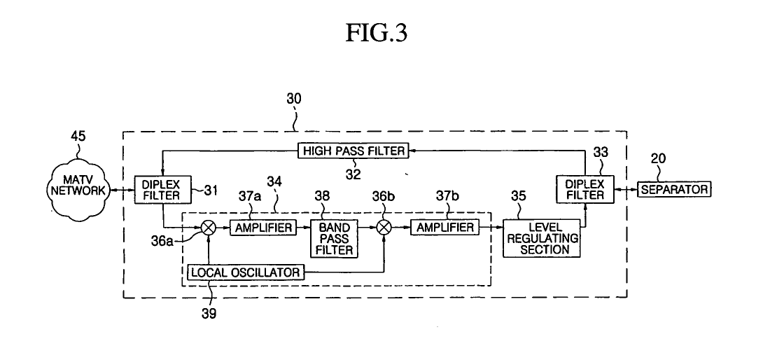

The detailed description of operation of the filtering apparatus 30 for internet service according to the present invention referring to FIG. 3 is as follows.

First, since internet upward/downward signals transmitted/received through the master antenna television network via the HFC network are classified into different frequency zones respectively and transmitted through one coaxial cable, each signal's frequency band is separated by a diplex filter 31 and 33 for removing noise of upward signal and downward signal respectively and the process is as follows. Internet downward signal transmitted from the internet network 10 and input into the filtering apparatus 30 for internet service through the separator 20 belongs to high frequency zone of 55-750 MHz among signals transmitted through the coaxial cable. Accordingly, the downward signal is separated from the upward/downward complex signals by the diplex filter 33 and filtered through a high pass filter 32 to remove frequency except the downward signal, i.e. noise. The downward signal from which the noise is removed is transmitted to each user's PC terminal 44 in the complex building 40 through the master antenna television network 45.

On the other hand, the internet upward signal transmitted from each user's PC terminal 44 in the complex building 40 to the internet network 10 belongs to 5˜42 MHz frequency zone among signals transmitted through the coaxial cable. The same signal is filtered by the filtering apparatus 30 for internet service according to the present invention and transmitted to the internet network 10 via the separator 20. However, in case of the internet upward signal using the master antenna television network 45, when the signal is input into the coaxial cable in the complex building 40, noise generated by various kinds of electric devices and devices generating electronic wave is input together with the upward signal to considerably decrease signal/noise ratio(S/N ratio) of the coaxial cable. Accordingly, if the S/N ratio is not increased to an optimum level by removing noise from the upward signal for providing internet service using the master antenna television network, the loss rate of data is rapidly increased and it becomes impossible to normally transmit data.

To overcome the loss of trustworthiness of data due to the noise inflow into the upward signal, the filtering apparatus 30 for internet service according to the present invention filters the upward signal and transmits the upward signal to the HFC network through the separator 20 as follows.

First, the upward signal is separated from the upward/downward complex signals by the diplex filter 31. Then, the separated upward signal is filtered by the band pass filter 38 to remove frequency except the upward signal, i.e., noise. The upward signal from which the noise is removed is transmitted to the internet network 10 through the diplex filter 33, the separator 20, the coaxial cable network 19, and the optional network 17.

More particularly, the upward signal separated by the diplex filter 31 is modulated into intermediate frequency zone by being mixed with intermediate frequency provided from a local oscillator 39 in a mixer 36a. The reason why the upward signal is filtered after being modulated in the intermediate frequency zone is for easier and more precise filtering.

The signal level of the upward signal decreased because of modulating into the intermediate frequency is restored to the original signal level before modulating by amplifying the signal by an amplifier 37a and noise of the upward signal is filtered by the band pass filter 38. Here, it is preferable to use a SAW filter having high quality of passing property and ability of perfectly excluding unnecessary band of signal as the band pass filter 38.

The upward signal from which the noise is removed by the band pass filter 38 is restored to the original frequency band by mixing again the intermediate frequency provided from the local oscillator 39 in the mixer 36b.

The upward signal from which the noise is removed by the band pass filter 38 and restored to the original frequency band by the amplifier 37a is amplified again by the amplifier 37b to restore the decreased signal level by the mixer 36b and transmitted to the coaxial cable network 19 via a level regulating section 35 and a diplex filter 33.

In the process described above, it is preferable to use a DBM(Double Balanced Mixer), as mixers 36a and 36b, having ability to minimize noise of the local oscillator and superior property of isolation of RF(Radio Frequency), IF(Intermediate Frequency), and LO(Local Oscillator) from each other.

In addition, the filtering apparatus for internet service according to the present invention may further comprise one or more sets of an amplifier and a band pass filter on an output end of the band pass filter 38. In this case, since the S/N ratio may be maintained to be higher when the filtering of the upward signal is performed by the filtering apparatus for internet service according to the present invention, it is possible to more trustworthily remove noise input into the upward signal.

On the other hand, the level regulating section 35 converts the upward frequency to corespond to various frequency bands of the upward signal used by plural internet service provider(ISP) when the internet service is provided through the HFC network.

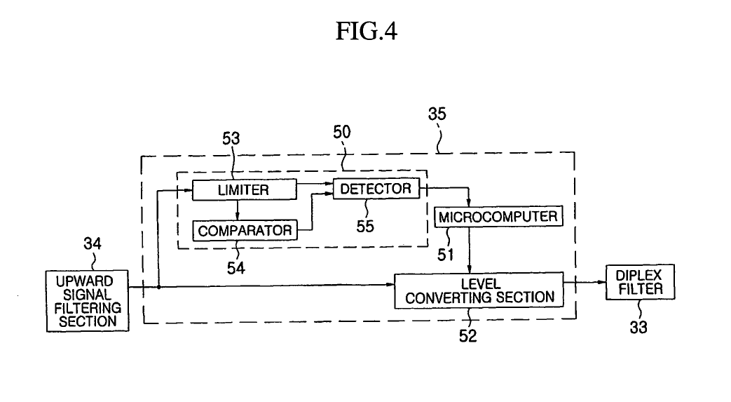

The detailed description of operation of the level regulating section 35 referring to FIG. 4 is as follows. The upward signal from which the noise is removed by the upward signal filter section 34 comprised of the mixer 36a and 36b, the amplifier 37a and 37b, and the band pass filter 38 is input to a level measuring section 50 and a level converting section 52, the upward signal input to the level measuring section 50 is converted into meter current signal expressing the strength of signal through a limiter 53 and a detector 55, and the same signal is converted again into voltage by a resistance(now shown) and an electrolytic condenser(not shown) of the output end and input to a microcomputer 51. Here, the limiter 53 prevents overload of the upward signal input to the level measuring section 50 by comparing the level of the upward signal with predetermined optimum level through a comparator 54.

The voltage signal input to the microcomputer 51 is converted into digital upward signal level by an A/D converter(Analog to Digital Converter; not shown) of the microcomputer 51 and compared with the predetermined optimum level of the upward signal by the microcomputer. When the upward signal level is higher or lower than the predetermined optimum level, the microcomputer 51 outputs digital control signal to the level converting section 52 to compensate the same. The digital control signal output to the level converting section 52 is converted into control signal by a D/A converter(Digital to Analog converter; not shown) comprised in the level converting section 52 itself and the level converting section 52 regulates the level of the upward signal to be output to the diplex filter 33 by using the control signal to tune the upward signal to the upward signal frequency band used by the ISP(Internet Service Provider) operating the internet network 10.

While the present invention has been described in detail with reference to the preferred embodiments, those skilled in the art will appreciate that various modifications and substitutions can be made thereto without departing from the spirit and scope of the present invention as set forth in the appended claims.

According to an aspect of the present invention, the master antenna television network installed in apartments or buildings may be used as the internet network and the internet service may be provided without additional installation of the internet network in any place where the master antenna television network is installed.

According to another aspect of the present invention, when the internet service of the HFC network is used through the upward signal frequency converting apparatus, it is possible to flexibly correspond to various frequency bands of the upward signal due to plural ISPs.

What is claimed is:

1. A filtering apparatus for internet service using master antenna television network comprising
a high pass filter for removing noise flowing into downward signal input to said master antenna television network via HFC network;
a band pass filter for removing noise flowing into upward signal transmitted from internet terminals to the HFC network through said master antenna television network; and
an amplifier, connected to a rear end of said band pass filter, for restoring the upward signal level decreased through said band pass filter to the original signal level by amplifying the filtered upward signal level.

2. The filtering apparatus according to claim 1, wherein plural band pass filters and amplifiers are mounted in an upward signal filtering area.

3. The filtering apparatus according to claim 1 further comprising a mixer, on a front end of said band pass filter, for filtering said upward signal at intermediate frequency by mixing said upward signal with intermediate frequency generated from a local oscillator to modulate said upward signal.

4. The filtering apparatus according to claim 1 further comprising a diplex filter for separating said upward signal and downward signal on front ends of said high pass filter and said band pass filter for filtering noises flowing into said upward signal and downward signal after separating each signal.

5. The filtering apparatus according to claim 1 further comprising a level regulating section, connected to a rear end of said amplifier, for regulating the level of said upward signal into predetermined optimum level.

6. The filtering apparatus according to claim 5, wherein said level regulating section comprises a level measuring section for measuring signal level of the upward signal flowing into said level regulating section and comparing said measured level with predetermined optimum level; and a level converting section for regulating the signal level of said upward signal to the predetermined optimum level.
